(19) United States
(12) Patent Application Publication
(10) Pub. No.: US 2026/0368928 A1
(43) Pub. Date: Nov. 19, 2026

(54) Automated Localization of Room Objects

(71) Applicant: Crestron Electronics, Inc., Rockleigh, NJ (US)

(72) Inventors: Peter Donaldson, Harvard, MA (US); Samay Pashine, Brookline, MA (US)

(73) Assignee: Crestron Electronics, Inc., Rockleigh, NJ (US)

(21) Appl. No.: 19/206,052

(22) Filed: May 13, 2025

(51) Int. Cl. G06T 7/80; G06T 7/70

(52) U.S. Cl. CPC G06T 7/80; G06T 7/70; G06T 2207/30204

(57) ABSTRACT

An automated spatial calibration system for AV devices uses fiducial marker boxes and PTZ cameras executing spiral scans. Computer-vision algorithms detect markers, compute homography and Perspective-n-Point poses, propagate to a world coordinate system, and validate results via confidence thresholds. A web-based GUI overlays live feeds and exports calibrated configurations. The system supports multi-room and cloud-based deployments, achieving sub-centimeter accuracy without manual measurement.

### FIELD OF THE INVENTION

The present invention relates to audio-visual system calibration. In particular, it concerns an automated method and apparatus for determining the spatial positions and orientations of cameras and microphones in a physical environment by using fiducial marker boxes and computer-vision-based scanning algorithms.

### BACKGROUND OF THE INVENTION

Modern conference rooms and lecture halls rely on networked Pan-Tilt-Zoom (PTZ) cameras and distributed microphone arrays to capture video and audio. Precise placement of these devices is critical to ensure that active speakers are properly framed, and audio sources are intelligibly recorded. Traditional calibration requires manual measurement of distances and angles—an error-prone, labor-intensive process that often yields inconsistent results. While automated systems have been proposed, they often require specialized calibration fixtures or manual input of multiple reference points. These requirements limit their applicability in dynamic or ad hoc environments. The present invention addresses these limitations by providing a flexible and efficient calibration method that minimizes human intervention and ensures high accuracy. There is therefore a need for an efficient, repeatable, and highly accurate calibration method that minimizes human intervention while providing sub-centimeter accuracy.

### SUMMARY OF THE INVENTION

An automated calibration system is provided comprising Marker Boxes each bearing Aruco fiducial markers on one or more distinct faces. Networked PTZ Cameras are provided which are capable of executing programmable spiral scan routines. In an embodiment a calibration controller is a computing unit that directs each PTZ camera to perform a spiral pan-tilt-zoom routine, capture video frames, and processes them to detect marker IDs and corner positions. In an embodiment, pose computation includes a vision module that calculates homography matrices for each detected marker, applies e.g., Perspective-n-Point (solvePnP) to extract camera-frame rotation and translation vectors, and propagates these to a world coordinate system anchored at an origin marker. In an embodiment, validation module outlier poses are rejected based on a user-defined accuracy threshold, and confidence scores are assigned; In an embodiment, a Graphical User Interface (GUI) Displays live camera feeds with overlaid marker boundaries, permits dynamic threshold adjustment, and exports calibrated configurations in JSON or Crestron 0.1brd format.

### BRIEF DESCRIPTION OF THE DRAWINGS

FIG. 1 is a block diagram illustrating the overall system architecture. The central component is the AutoSetup Controller (100), which interfaces with multiple PTZ Cameras (110) for capturing video frames. Marker Boxes (120) are strategically placed within the environment to serve as reference points for calibration. The system also includes Microphones (130) for audio calibration and a GUI Terminal (140) for user interaction and configuration.

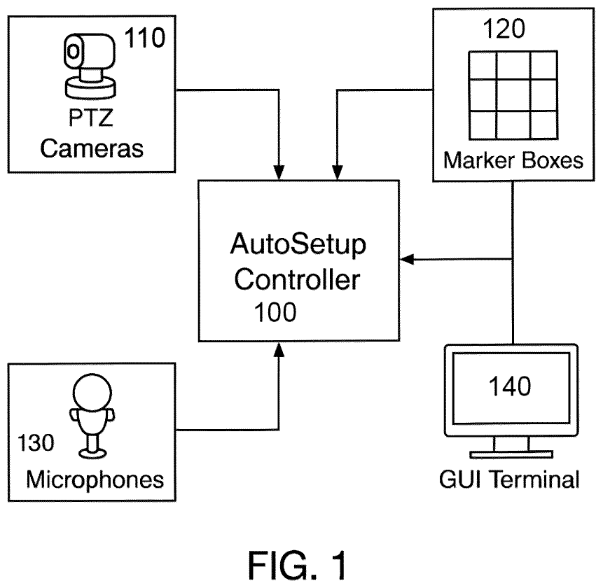

FIG. 2 is a flowchart of the calibration process, illustrating steps: Initialize System (200), Place Markers (210), Spiral Search (220), Marker Detection (230), Position Calculation (240), Validation (250), and Final Output (260).

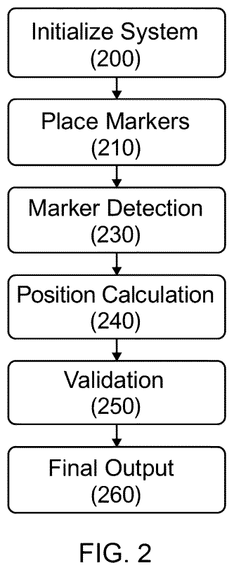

FIG. 3 is an isometric view of a room layout showing marker boxes (124) each bearing one or more markers (125), positioned relative to microphones (130) and one or more mounted PTZ Cameras (110).

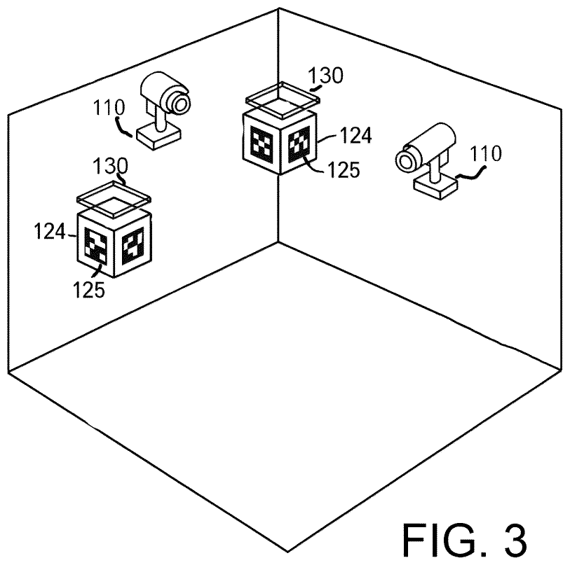

FIG. 4 illustrates one embodiment of a PTZ camera's spiral search pattern, starting at orientation, incrementing pan by Δθ and tilt by Δφ, with overlapping fields of view until a coverage threshold is reached.

FIG. 5 is one embodiment of a screenshot of the graphical user interface, showing the live camera feed (410), marker overlay, position readout panel (430), accuracy threshold slider (440), and the export button (450).

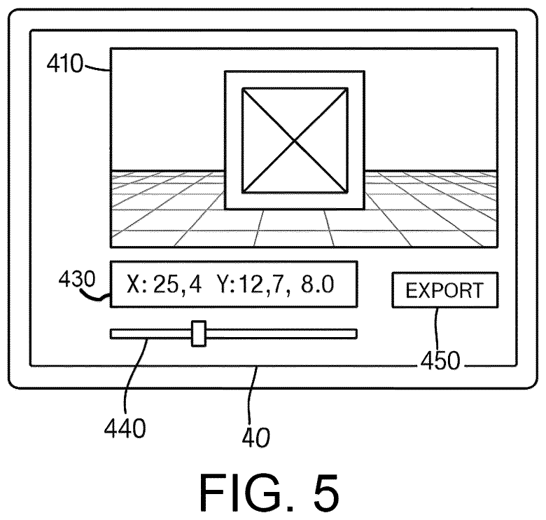

FIG. 6 is a UML class diagram of the AutoSetup singleton class (500), depicting fields for MarkerPoseList (510), CameraPoseList (520), AccuracyThreshold (530), and methods estimatePosition( ) (540) and validate( ) (550).

### DETAILED DESCRIPTION

According to one embodiment, each marker box (120) comprises a rigid, anti-reflective plastic shell. In one embodiment, five Aruco markers are centrally affixed on distinct faces (front, left, right, rear, and bottom.) Each marker's unique identifier is preprogrammed into the calibration controller's lookup table, facilitating immediate recognition upon first detection. Alternative embodiments may include lightweight aluminum alloy casings with integrated bubble level (135) and laser-etched fiducial patterns to ensure rugged durability. In another embodiment, other box sizes and aspect ratios are permissible to support deployment by enabling detection at distances up to 30 meters and beyond. Detection distances may vary based on marker size, zoom level, lighting conditions, and the zoom level of the optical zoom PTZ camera variant.

In one embodiment, the mounting apparatus of the marker box provides secure attachment directly to microphones 130. An alternate embodiment incorporates a prefabricated kit based alignment mount mechanism for rapid attachment and detachment.

In one embodiment, Initial System Configuration and Multi-Zone Calibration Upon power-up, the operator authenticates to the GUI (140) via HTTPS and provides core parameters: number of microphones (NumMics), accuracy threshold (AccThreshold), microphone mount heights (z-axis), and floor plan scale. The a first marker box (120) at the a reference microphone (130) establishes the global coordinate origin. The operator then selects Single-Room or Multi-Zone mode. In Multi-Zone mode, the environment is partitioned into discrete zones—each calibrated independently before a unified propagation routine merges zone graphs. This feature accommodates divisible spaces, enabling rapid recalibration when walls or partitions are reconfigured.

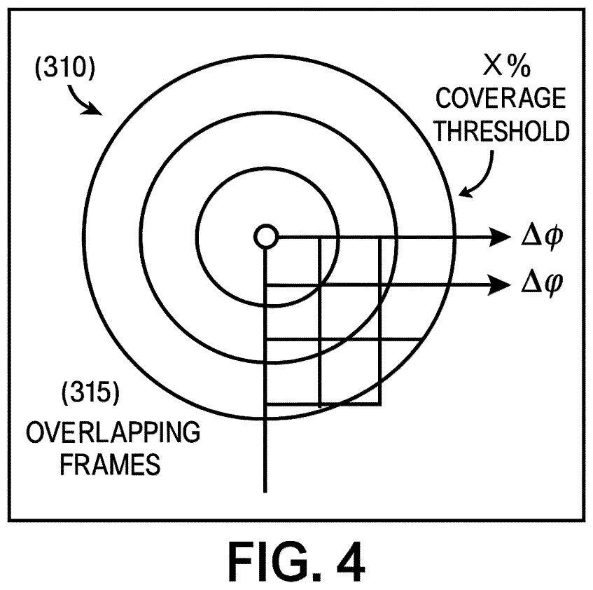

Referring to FIG. 4, showing a Spiral Search Algorithm and Auto-Framing Process by referring. In an embodiment, the spiral Search routine initiates at pan=0°, tilt=0°, with configurable increments Δθ and Δφ with other increment values being permissible. The calibration controller dynamically adjusts the pan (Δθ) and tilt (Δφ) increments based on real-time detection feedback. In one embodiment, if the system detects a high ratio of missed markers, the controller reduces the pan increment (Δθ) by 50% to increase the density of the coverage area, thereby improving the likelihood of marker detection. Overlapping fields of view (315) ensure that partially obstructed markers, such as those behind decorative room elements, are captured across multiple frames. The Vision Module applies detectMarkers( ) to each frame; wherein each PTZ camera pan, tilt, and zoom values are directly computed from the detected marker's pixel-space area thereby dynamically adjusting its optical zoom. In an embodiment, detectMarkers( ) uses a rectified marker face's pixel space area to calculate the exact required PTZ values to frame the marker at a specific size and subsequently got directly to that pan/tilt/zoom value.

In an alternative embodiments, upon detection of a marker exceeding a pixel-area threshold, an auto-framing subroutine triggers a first zoom to 2×, recenters on the marker centroid, and performs a second detection. If visibility metrics remain above threshold, and other zoom levels are permissible, they can be executed.

According to one embodiment, in Marker Detection, Homography, and Pose Estimation, each auto-framed image is processed to extract coordinates of the Aruco pattern. This is accomplished using Quad Fitting, Line Fitting, and Homography Refinement, independent of a fixed pixel radius. A homography matrix H is computed by solving a Direct Linear Transform (DLT) for the planar mapping to the known marker geometry. The solvePnP( ) routine then utilizes the camera's intrinsic calibration parameters (eg. focal length, principal point, and distortion coefficients) to derive rotation vectors R_m and translation vectors t_m in the camera frame. Converting R_m via Rodrigues'formula yields the rotation matrix mR_c. In another embodiment, using supporting stereo calibration, pairs of cameras capture synchronized frames, stereo triangulation refines t_m with depth estimation, improving pose accuracy.

In one embodiment, Graph-Based Pose Propagation and Confidence Metrics World-frame marker poses are anchored at the origin marker and propagated using a graph-based breadth-first search. Each edge in the graph represents a relative transform between two markers observed concurrently, labeled with covariance matrices representing measurement uncertainty. In one embodiment, employing graph-based algorithms to propagate absolute positions from devices with higher confidence to devices with lower initial confidence can be used to improve positional accuracy. In one embodiment, intrinsic camera parameters including focal length, principal point, and lens distortion coefficients are used for pose computation.

In an embodiment, Calculating Camera Position is calculated as:
w Pm=Marker Position in the world frame,
w Rm=Marker Rotation in the world frame,
mRPc=Camera Relative Position in the marker frame,
mRc=Camera Rotation in the marker frame,
Camera Relative Position in the world frame, w RPc=w Rm * mRPc
Camera Rotation in the world frame, w Rc=w Rm * mRc
Camera Position in the world frame, w Pc=w Pm+w RPc

Rectify the Pan, and Tilt value from the camera Rotation to get the actual orientation of the camera in the world frame.

In an embodiment, Calculating Marker Position is calculated by following the same procedure as above just other way around i.e. We already have Camera information in the world frame, and we have Relative position and orientation of the Marker in the camera frame, we use the rotation of the camera to transform the relative position and orientation of the marker and proceed to calculate the marker location. The only additional step is; after calculating the position and orientation of one marker we auto calculate the position and orientation of other markers on the same box.

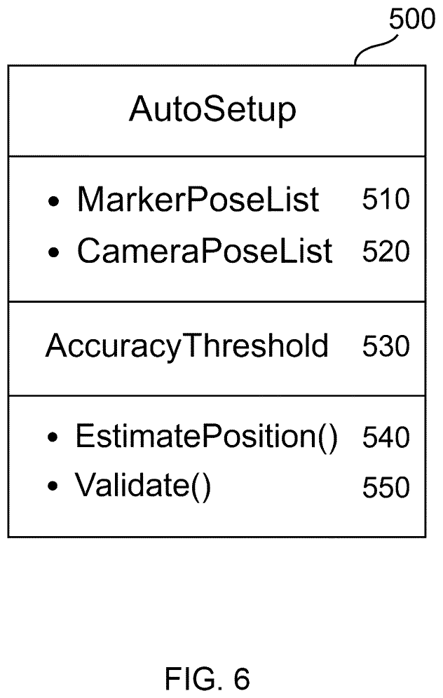

Referring to FIG. 6, in an embodiment, the Software Architecture and Extensible Framework comprises a calibration controller implements a singleton class (500) containing data structures for MarkerPoseList (510) and CameraPoseList (520), each entry comprising pose vectors and confidence scalars. Core methods include initialize( ), startCalibration( ), estimatePosition( ), validate( ), and exportResults( ). In an embodiment, a plugin architecture loads modular device adapters at runtime, allowing support for additional sensor types such as infrared beacons or depth cameras. Inter-module communication leverages a message bus with low-latency data exchange.

In an embodiment, User Interface and Control Integration is a web-based graphical user interface (GUI) (140) designed as a responsive single-page application built using React and WebSocket streams. In an embodiment, the interface provides real-time feedback and control, displaying live video feeds with overlaid marker boundaries. In one embodiment, Users can adjust calibration parameters dynamically and export the final configurations in various formats, such as JSON or Crestron 0.1brd. In one embodiment, live video feeds (410) are overlaid with marker edges and centroid points. In one embodiment, the position readout panel (430) lists device IDs, 3D coordinates, Euler angles, and confidence percentages. In one embodiment, users adjust the accuracy threshold via a slider (440), dynamically updating validation in real time. In one embodiment, a textbox can be used instead. In one embodiment, Control buttons for Start, Pause, and Export (450) manage the calibration workflow. In one embodiment, the GUI can support custom integration plugins that push configuration directly to various control systems via secure API calls.

In one embodiment, network, necurity, and cloud Orchestration communications between the GUI and controller use TLS 1.2 with mutual certificate authentication. In one embodiment, REST endpoints (/autosetup/start,/autosetup/status) use JWT tokens with role-based scopes. In one embodiment, PoE+network discovery via LLDP can identify cameras and marker-powered fixtures. In one embodiment, cloud deployments can be used to have controllers register to a Kubernetes-managed Orchestrator via gRPC, registering device inventories and calibration results. Other cloud based managements scenarios include those such as Crestron's XiO could services.

In some embodiments, the average calibration time per camera is under two minutes. In one embodiment, scheduled maintenance routines poll device firmware versions via SNMP, perform marker integrity checks by tracking long-term confidence trends, and initiate secure firmware updates via HTTPS PUT to a location eg./camera/update. In one embodiment, Marker replacement alerts trigger when average detection confidence drops below 85%.

In one embodiment, SLAM-based markerless calibration using RGB-D sensors and graph-SLAM algorithms for feature-based mapping. In one embodiment, Machine-learning modules may predict optimal marker placements based on room geometry and lighting conditions. In one embodiment, augmented reality assistance via mobile devices could guide technicians to desired placement points. In one embodiment, self-healing calibration uses redundant marker networks to automatically compensate for dropped nodes.

In one embodiment hybrid marker patterns combining Aruco and AprilTag symbols can be employed to increase robustness against partial occlusions and varied environmental conditions. In one embodiment, marker boxes may be outfitted with LED illumination arrays synchronized to camera frame capture, improving detection reliability in low-light or backlit scenarios. In one embodiment, aerial drones equipped with marker arrays can perform overhead calibration sweeps, dynamically adjusting altitude and scanning resolution.

In one embodiment, the system can be enhanced with mobile calibration platforms including autonomous ground robots. In one embodiment, these robots traverse the environment, projecting structured light patterns to create temporary fiducial landmarks. This approach enables continuous calibration updates and adapts to changes in the environment, ensuring consistent accuracy over time. In one embodiment, cloud-based analytics services collect anonymized calibration metadata to train predictive models that recommend optimal marker placement, scan parameters, and equipment configurations for given room geometries.

What is claimed is:

1. A method for spatial calibration of audio-visual equipment comprising:
a) providing a plurality of fiducial marker boxes, each having a set of unique two-dimensional fiducial markers affixed forming a pixel-space area on distinct planar faces;
b) directing at least one Pan-Tilt-Zoom (PTZ) camera to execute a spiral scanning routine, iteratively incrementing pan by Δθ and tilt by Δφ to cover an environment with overlapping fields of view, where increments are dynamically adjustable based on detection feedback;
c) capturing image frames at each scan orientation and processing each frame to detect fiducial markers;
d) computing camera-frame pose estimations for each detected marker by:
i. computing a homography matrix from detected corner coordinates and known marker geometry;
ii. applying a Perspective-n-Point (PnP) algorithm using intrinsic camera parameters including focal length, principal point, and camera distortion coefficients;
e) propagating relative marker poses to a common coordinate system anchored at a reference marker through a graph-based traversal that improves confidence using confidently localized devices;
f) alerting users about devices with confidence scores below a configurable threshold instead of rejecting them outright; and
g) presenting final spatial positions and orientations via a graphical user interface.

2. The method of claim 1, wherein each said marker box is marked with at least one of its said markers being visible.

3. The method of claim 1, wherein PTZ camera pan, tilt, and zoom values are directly computed from the detected marker's pixel-space area thereby dynamically adjusting its optical zoom.

4. The method of claim 1, wherein the spiral scanning coverage threshold is user-defined.

5. The method of claim 1, wherein marker detection employs Quad Fitting, Line Fitting, and Homography Refinement, independent of a fixed pixel radius.

6. The method of claim 1, further comprising employing graph-based algorithms to propagate absolute positions from devices with higher confidence to devices with lower initial confidence, thereby improving positional accuracy.

7. The method of claim 1, wherein the Perspective-n-Point algorithm uses intrinsic camera parameters including focal length, principal point, and lens distortion coefficients for pose computation.

8. The method of claim 1, wherein the confidence threshold may be configured through multiple user-input methods without a fixed input requirement.

9. A system for spatial calibration of audio-visual equipment comprising:
multiple PTZ cameras;
multiple fiducial marker boxes each bearing one or more markers;
a calibration controller configured to perform the steps of:
a) providing a plurality of fiducial marker boxes, each having a set of unique two-dimensional fiducial markers affixed forming a pixel-space area on distinct planar faces;
b) directing at least one Pan-Tilt-Zoom (PTZ) camera to execute a spiral scanning routine, iteratively incrementing pan by Δθ and tilt by Δφ to cover an environment with overlapping fields of view, where increments are dynamically adjustable based on detection feedback;
c) capturing image frames at each scan orientation and processing each frame to detect fiducial markers;
d) computing camera-frame pose estimations for each detected marker by computing a homography matrix from detected corner coordinates and known marker geometry and applying a Perspective-n-Point (PnP) algorithm using intrinsic camera parameters including focal length, principal point, and camera distortion coefficients;
e) propagating relative marker poses to a common coordinate system anchored at a reference marker through a graph-based traversal that improves confidence using confidently localized devices;
f) providing a web-based graphical user interface allowing dynamic interaction and visualization comprising providing alerts users about devices with confidence scores below a configurable threshold and presenting final spatial positions and orientations.

10. The system of claim 9, further comprising a singleton software architecture with data structures comprising: MarkerPoseList, CameraPoseList, and methods for initialization, calibration, pose estimation, validation, and result exporting.

11. The system of claim 9, wherein the graphical user interface allows flexible and real-time adjustment of confidence thresholds through one or more GUI interface elements.

12. The system of claim 9, further comprising an extensible plugin framework enabling third-party device integration and calibration.

13. A non-transitory computer-readable medium storing instructions executable by the calibration controller to perform:
a) providing a plurality of fiducial marker boxes, each having a set of unique two-dimensional fiducial markers affixed forming a pixel-space area on distinct planar faces;
b) directing at least one Pan-Tilt-Zoom (PTZ) camera to execute a spiral scanning routine, iteratively incrementing pan by Δθ and tilt by Δφ to cover an environment with overlapping fields of view, where increments are dynamically adjustable based on detection feedback;
c) capturing image frames at each scan orientation and processing each frame to detect fiducial markers;
d) computing camera-frame pose estimations for each detected marker by computing a homography matrix from detected corner coordinates and known marker geometry and applying a Perspective-n-Point (PnP) algorithm using intrinsic camera parameters including focal length, principal point, and camera distortion coefficients;
e) propagating relative marker poses to a common coordinate system anchored at a reference marker through a graph-based traversal that improves confidence using confidently localized devices; and
f) providing a web-based graphical user interface allowing dynamic interaction and visualization comprising providing alerts users about devices with confidence scores below a configurable threshold and presenting final spatial positions and orientations.

14. The computer-readable medium of claim 13, wherein the instructions cause the controller to alert users about devices below confidence thresholds; and
export validated configurations in either JSON or Crestron 0.1brd file format.

15. A PTZ camera configured to execute adaptive spiral scanning routines and perform precise auto-framing based directly on marker pixel-space calculations using a fiducial marker box for audio-visual equipment calibration comprising an enclosure having at least one fiducial marker thereon; wherein said PTZ camera is further configured to transmit processed frames to a calibration controller for spatial pose determination.

16. The system of claim 9, capable of exporting calibration results via a secure REST API to an external control system.

17. The method of claim 1, further comprising markerless calibration using depth-sensing cameras and simultaneous localization and mapping (SLAM) algorithms, allowing calibration without predefined markers.

18. The system of claim 9, further comprising cloud-based orchestration support via registration to a central orchestrator, enabling multi-site calibration scheduling.
